(19) United States
(12) Patent Application Publication
(10) Pub. No.: US 2017/0107922 A1
(43) Pub. Date: Apr. 20, 2017

(54) CONTROL SYSTEM OF INTERNAL COMBUSTION ENGINE

(71) Applicant: TOYOTA JIDOSHA KABUSHIKI KAISHA, Toyota-shi (JP)

(72) Inventor: Yukihiro NAKASAKA, Shizuoka-ken (JP)

(73) Assignee: TOYOTA JIDOSHA KABUSHIKI KAISHA, Toyota-shi (JP)

(21) Appl. No.: 15/294,903

(22) Filed: Oct. 17, 2016

(30) Foreign Application Priority Data
Oct. 19, 2015 (JP) 2015-205949

(51) Int. Cl. F02D 37/02; F02D 41/30; F02P 5/145; F02D 41/40

(52) U.S. Cl. CPC F02D 37/02; F02D 41/401; F02D 41/3005; F02P 5/145

(57) ABSTRACT

A control system according to one aspect of the present invention is applied to an engine. The engine comprises a cylinder injector and an intake valve driving device capable of changing the closing timing of an intake valve. If the execution condition is satisfied when the injection timing of fuel of the cylinder injector is before intake bottom dead center and an Atkinson cycle is carried out, the engine delays the injection timing of the fuel of the cylinder injector to a time after intake bottom dead center, injects the fuel, then executes fuel cut control.

### TECHNICAL FIELD

The present invention relates to a control system of an internal combustion engine comprising an intake valve driving device capable of changing a closing timing of an intake valve.

### BACKGROUND ART

Known in the past has been a control system of a spark-ignition type internal combustion engine which comprises an intake port injector injecting fuel into an intake port and an intake valve driving device capable of changing a closing timing of the intake valve, and performs an Atkinson cycle improving an engine efficiency by making an expansion ratio larger compared with a compression ratio (for example, see PLT 1).

The system disclosed in PLT 1 (Below, referred to as the “conventional system”) is configured to set the closing timing of the intake valve to a time after intake bottom dead center and push back a part of the air once taken into a cylinder to the inside of the intake port so as to delay the compression start timing. Accordingly, in the conventional system, by delaying the compression start timing, an Atkinson cycle that makes the expansion ratio larger compared with the compression ratio is realized and thereby the engine efficiency is improved.

### CITATION LIST

### Patent Literature

PLT 1. Japanese Patent Publication No. 2000-073901A

### SUMMARY OF INVENTION

However, in the conventional system, if the closing timing of the intake valve becomes after intake bottom dead center in order to perform the Atkinson cycle, after the fuel injected during the intake stroke once flows into the cylinder, it is blown back to the inside of the intake port in a period after intake bottom dead center where the intake valve is open. At this time, if fuel cut control for suspending fuel injection from the intake port injector is performed, the fuel which was blown back to the inside of the intake port before the fuel cut control again flows into the cylinder during the fuel cut control. As a result, the air-fuel mixture containing the fuel which again flowed into the cylinder during the fuel cut control is liable to not completely burn during the fuel cut control, but end up blowing through to the inside of the exhaust passage as unburned gas.

The present invention is made in order to deal with the problems explained above. That is, one of the objects of the present invention is to provide a “control system of an internal combustion engine” (below, referred to as the “system of the present invention”) which is applied to an internal combustion engine for realizing an Atkinson cycle and suppresses blow through of the unburned gas to the exhaust passage when performing the fuel cut control.

The system of the present invention is applied to an internal combustion engine comprising a spark plug, an intake valve, a cylinder injector injecting fuel into a cylinder, and an intake valve driving device driving the intake valve so as to close after intake bottom dead center.

Further, the system of the present invention comprises a spark plug controlling means, an injection controlling means, and a fuel cut controlling means. The spark plug controlling means is configured to control ignition of the spark plug.

The injection controlling means is configured to switch an injection timing of a fuel of the cylinder injector to a first injection timing of a period before intake bottom dead center and to a second injection timing of a period after intake bottom dead center.

The fuel cut controlling means is configured to execute a fuel cut control for suspending fuel injection of the cylinder injector when a predetermined execution condition is satisfied.

Further, the system of the present invention is configured to execute the fuel cut control after injecting the fuel at the second injection timing and executing ignition if the execution condition is satisfied in a cycle where the injection timing of the fuel of the cylinder injector is the first injection timing.

According to this, the fuel injection timing of the cylinder injector is delayed to a time after intake bottom dead center, therefore the amount of the fuel which is blown back to the inside of the intake passage in the period when the intake valve is open decreases. As a result, the amount of the fuel which flows into the exhaust passage as unburned gas when the fuel cut control is carried out can be reduced.

Further, in one aspect of the system of the present invention, the injection timing at the second injection timing is after closing of the intake valve.

According to this, since the second injection timing is set to a time after closing of the intake valve, the amount of the fuel which is blown back to the inside of the intake passage becomes zero. Accordingly, the amount of the fuel which is blown back to the inside of the intake passage can be reduced compared with the case where the fuel is injected in a period after intake bottom dead center when the intake valve is open. As a result, if fuel cut control is carried out, the amount of the fuel which flows into the exhaust passage as unburned gas can be reduced compared with the case where the fuel is injected in a period after intake bottom dead center when the intake valve is open.

Further, in another aspect of the system of the present invention, the injection timing in the second injection period is a time before closing of the intake valve and at which the pressure in the cylinder rises per unit crank angle.

According to this, the amount of the fuel which is blown back to the inside of the intake passage can be reduced compared with the case where the fuel is injected before intake bottom dead center. As a result, if the fuel cut control is carried out, the amount of the fuel which flows into the exhaust passage as the unburned gas can be reduced compared with the case where the fuel is injected in a period after intake bottom dead center when the intake valve is open. In addition, compared with the case where the fuel injection timing from the cylinder injector is set to a time after closing of the intake valve, the time of atomizing the fuel can be made longer. As a result, deterioration of combustion can be suppressed compared with the case where the fuel injection timing from the cylinder injector is set to a time after closing of the intake valve.

In this regard, if the internal combustion engine is a multi-cylinder internal combustion engine, if spark plugs ignite fuel during fuel cut control, in some of the cylinders, the air-fuel mixture which contains the fuel flowing again to the insides of the cylinders after being blown back to the inside of the intake passage will burn inside the cylinders, therefore high temperature exhaust gas will flow in the exhaust passage. At this time, the air-fuel mixture which did not completely burn in other cylinders, but flows to the exhaust passage is liable to ignite in the exhaust passage due to the high temperature exhaust gas and causes “after fire”.

For this reason, in one aspect of the system of the present invention, if the internal combustion engine has a plurality of cylinders, the spark plug controlling means is configured to control the spark plugs so as not to ignite fuel during the fuel cut control.

According to this, the air-fuel mixture which contains the fuel flowing again to the insides of the cylinders after being blown back to the inside of the intake passage in a part of the cylinders is kept from being burned. As a result, flow of high temperature exhaust gas in the exhaust passage is suppressed, therefore occurrence of “after fire” due to the air-fuel mixture which did not completely burn, but flowed into the exhaust passage can be suppressed.

Other objects, features, and accompanying advantages of the present invention will be easily understood from the explanation of embodiments of the present invention given with reference to the following drawings.

### BRIEF DESCRIPTION OF DRAWINGS

FIG. 1 is a schematic view of an internal combustion engine according to one embodiment of the present invention.

FIG. 2 is a view of valve characteristics of an intake valve according to an embodiment of the present invention.

FIG. 3 is a timing chart of fuel cut control according to an embodiment of the present invention.

FIG. 4 is a flow chart showing a routine of fuel cut control which is performed by a CPU according to an embodiment of the present invention.

FIG. 5 is a view showing a fuel injection timing of a cylinder injector in control by a CPU according to a modification of the embodiment of the present invention.

### DESCRIPTION OF EMBODIMENTS

Below, the “control system of an internal combustion engine according to the present invention” (below, sometimes referred to as the “present control system”) will be explained with reference to the drawings.

[Schematic Configuration]

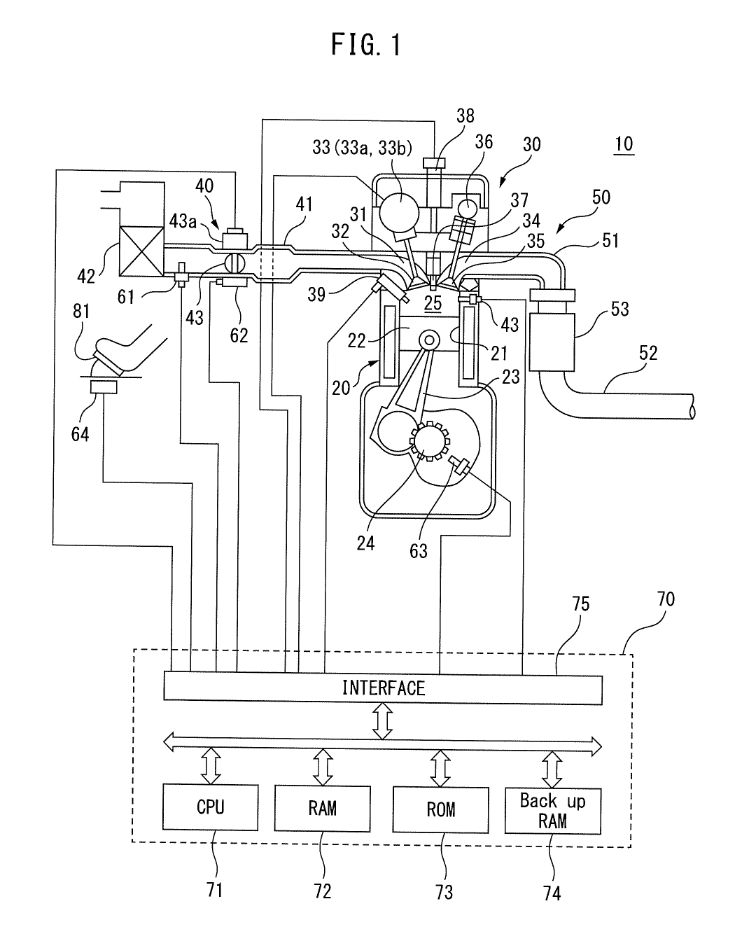

The control system according to an embodiment of the present invention (below, referred to as the “present control system”) is applied to a spark ignition type multi-cylinder internal combustion engine 10 (below, referred to as the “engine”) shown in FIG. 1. Note that, FIG. 1 shows only the cross-section of a specific cylinder, but other cylinders are provided with the same configuration as well.

This engine 10 includes a cylinder block 20, a cylinder head 30 fixed on the cylinder block 20, an intake system 40 for supplying air to the cylinder block 20, and an exhaust system 50 for discharging the exhaust gas from the cylinder block 20 to the outside.

The cylinder block 20 includes a cylinder 21, a piston 22, a connecting rod 23, and a crank shaft 24. The piston 22 reciprocally moves inside the cylinder, the reciprocating movement of the piston 22 is transmitted through the connecting rod 23 to the crank shaft 24, and thereby the crank shaft 24 rotates. The top face of the piston 22, the wall surface of the cylinder 21, and the bottom surface of the cylinder head 30 define a combustion chamber (cylinder) 25.

The cylinder head 30 comprises an intake port 31 communicated with the combustion chamber 25, an intake valve 32 opening and closing the intake port 31, an intake valve driving device 33 driving the intake valve 32 and being able to change the valve characteristic of the intake valve 32, an exhaust port 34 communicated with the combustion chamber 25, an exhaust valve 35 opening and closing the exhaust port 34, an exhaust camshaft 36 driving the exhaust valve 35, a spark plug 37, an igniter 38 including an ignition coil for generating a high voltage to be given to the spark plug 37, and a cylinder injector 39 injecting the fuel into the cylinder 25. The cylinder injector 39 controls the injection of the fuel so that the fuel is supplied to the inside of the combustion chamber 25 in the period when the intake port 31 is open.

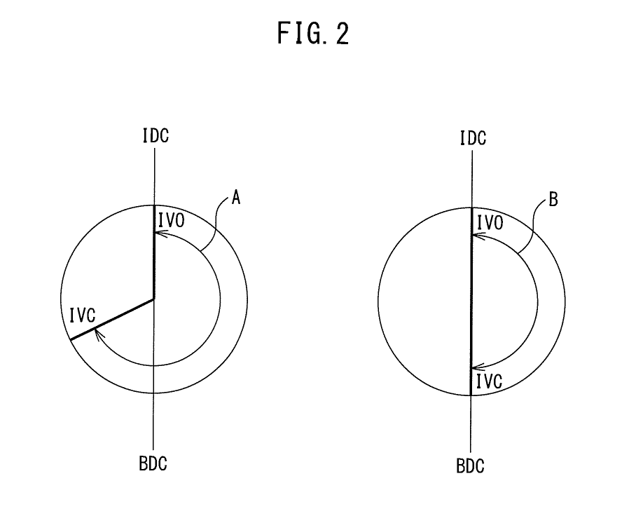

The intake valve driving device 33 is a variable valve drive mechanism having the function of switching the valve characteristic of the intake valve 32 to two types of valve characteristics. A in FIG. 2 represents a case where the valve characteristic of the intake valve 32 becomes a first valve characteristic. The first valve characteristic is the valve characteristic of a large working angle 32a. The intake valve opening timing IVO is the timing of intake top dead center TDC, while the intake valve closing timing IVC is the timing after intake bottom dead center BDC (for example ABDC60 to 70° after bottom dead center). B in FIG. 2 represents a second valve characteristic. The second valve characteristic is the valve characteristic of a small working angle 32b. The intake valve opening timing IVO is the timing of intake top dead center TDC, while the intake valve closing timing IVC is the timing of bottom dead center BDC.

The intake system 40 comprises an intake pipe 41 including an intake manifold which is communicated with the intake port 31 and forms the intake passage together with the intake port 31, an air filter 42 provided at the end part of the intake pipe 41, a throttle valve 43 which is located in the intake pipe 41 and makes the opening cross-section of the intake passage variable, and a throttle valve actuator 43a which configures the throttle valve driving means.

The exhaust system 50 has an exhaust manifold 51 communicated with the exhaust port 34, an exhaust pipe 52 connected to the exhaust manifold 51, and a three-way catalyst 53 arranged on the exhaust pipe 52.

On the other hand, this system comprises a hot wire air flow meter 61, throttle position sensor 62, crank position sensor 63, accelerator opening sensor 64, and cylinder inner pressure sensor 65.

The hot wire air flow meter 61 detects a mass flow rate per unit crank angle of the intake air flowing in the intake pipe 41 and outputs a signal representing the mass flow rate Ga.

The throttle position sensor 62 detects the degree of opening of the throttle valve 43 and outputs a signal representing the throttle valve opening TA.

The crank position sensor 63 is configured to output a pulse whenever the crank shaft 24 rotates by 10 degrees. The pulse output from the crank position sensor 63 is converted to a signal representing the engine rotation speed NE by an electronic control unit 70 which will be explained later. Further, the electronic control unit 70 calculates the crank angle (absolute crank angle θ) of the engine 10 based on the signal from the crank position sensor 63.

The accelerator opening sensor 64 detects the accelerator opening of the accelerator pedal 81 operated by the driver and outputs a signal representing the accelerator opening Accp of the accelerator pedal 81. The accelerator opening Accp of the accelerator pedal 81 is one parameter representing the magnitude of the load of the engine 10.

One cylinder inner pressure sensor 65 is provided in each of the plurality of cylinders. The cylinder inner pressure sensor 65 is configured to detect the pressure in the corresponding combustion chamber 25 as the cylinder inner pressure. The cylinder inner pressure of each cylinder is acquired by the electronic control unit 70 whenever the crank angle changes by a minute angle Δθ. Further, acquired cylinder inner pressure P is stored in a RAM 73 which will be explained later in the form of the cylinder inner pressure P(θ) related to the crank angle θ of the corresponding cylinder.

The electronic control unit 70 is a known microprocessor including a CPU 71, ROM 72, RAM 73, backup RAM 74, interface 75 including an AD converter, etc.

The interface 75 is connected to the sensors 61 to 64 described above and is configured to supply the signals from these sensors to the CPU 71. Further, the interface 75, in response to an instruction from the CPU 71, outputs drive signals to the intake valve driving device 33 and throttle valve actuator 43a, outputs an injection instruction signal to the cylinder injector 39 of each cylinder, and outputs an ignition signal to the igniter 38 of each cylinder.

The present control system performs an “Atkinson cycle” by switching the valve characteristic of the intake valve 32. Further, the present control system performs “fuel cut control” suspending fuel injection from the cylinder injector 39. Further, if the execution condition explained later is satisfied at the time when the Atkinson cycle is carried out, the present control system switches the fuel injection timing from the cylinder injector 39 to a time after intake bottom dead center, ignites fuel from the spark plug 37, and then performs fuel cut control. For this reason, below, the Atkinson cycle and fuel cut control will be explained in order.

[Atkinson Cycle]

The Atkinson cycle is a cycle making the expansion ratio in the engine 10 larger compared with the compression ratio. In the present control system, this is realized by setting the closing timing of the intake valve 32 at the time after intake bottom dead center. Specifically, the present control system sets the valve characteristic of the intake valve 32 to the first valve characteristic by the intake valve driving device 33. According to this, the closing timing of the intake valve 32 becomes a time after intake bottom dead center, so the expansion ratio can be made larger compared with the compression ratio and therefore the engine efficiency of the engine 10 can be improved.

[Fuel Cut Control]

The CPU 71 provided in the electronic control unit 70 of the present control system performs a fuel cut control suspending the fuel injection by the cylinder injector 39 when the engine 10 becomes a predetermined execution condition. The predetermined execution condition (below, referred to as the “execution condition”) is for example a case where the output torque of the engine 10 is reduced. Specifically, when the accelerator opening Accp of the accelerator pedal 81 becomes a predetermined amount or less (for example, Accpoff at which the accelerator opening becomes zero), the present control system judges that the execution condition is satisfied and performs the fuel cut control. The CPU 71 can smoothly reduce the output torque of the engine 10 by the fuel cut control and can improve the fuel economy by suppressing unnecessary fuel consumption.

Further, the CPU 71 is configured to switch the fuel injection timing from the cylinder injector 39 to a time after closing of the intake valve 32, ignites fuel from the spark plug 37, and then executes fuel cut control, if the execution condition is satisfied when the intake valve 32 has the first valve characteristic and the fuel injection timing from the cylinder injector 39 is before intake bottom dead center. Further, the CPU 71 is configured so as not to ignite fuel by the spark plug 37 when the fuel cut control is executed.

Explained specifically, at the time when the intake valve 32 has the first valve characteristic and the fuel injection timing of the cylinder injector 39 is a time before intake bottom dead center, the ECU 71 judges that the execution condition is satisfied if the accelerator opening Accp of the accelerator pedal 81 becomes Accpoff at which the accelerator opening becomes zero. Next, the ECU 71 sets the fuel injection timing from the cylinder injector 39 to a time after closing of the intake valve 32 and performs controls so that ignition is carried out from the spark plug 37. Next, the ECU 71 suspends the fuel injection from the cylinder injector 39 (that is, perform fuel cut control) after the fuel is injected from the cylinder injector 39 after closing of the intake valve 32 and the ignition is carried out from the spark plug 37. Further, the ECU 71 executes fuel cut control and suspends the ignition from the spark plug 37.

According to this, the fuel injection timing of the cylinder injector is delayed to a time after closing of the intake valve 32, whereby the amount of the fuel which is blown back to the inside of the intake passage in the period where the intake valve is open after intake bottom dead center becomes zero. As a result, the amount of the fuel which flows into the exhaust passage as unburned gas when fuel cut control is carried out can be reduced. In addition, the present control system is configured to suspend ignition from the spark plug 37 during the fuel cut control, therefore combustion inside a cylinder of the air-fuel mixture which contains the fuel again flowing into the cylinder after being blown back to the inside of the intake passage in a part of the cylinders is suppressed. As a result, flow of the high temperature exhaust gas in the exhaust passage is suppressed, therefore the occurrence of “after fire” by the air-fuel mixture which did not completely burn and flowed to the exhaust passage can be suppressed.

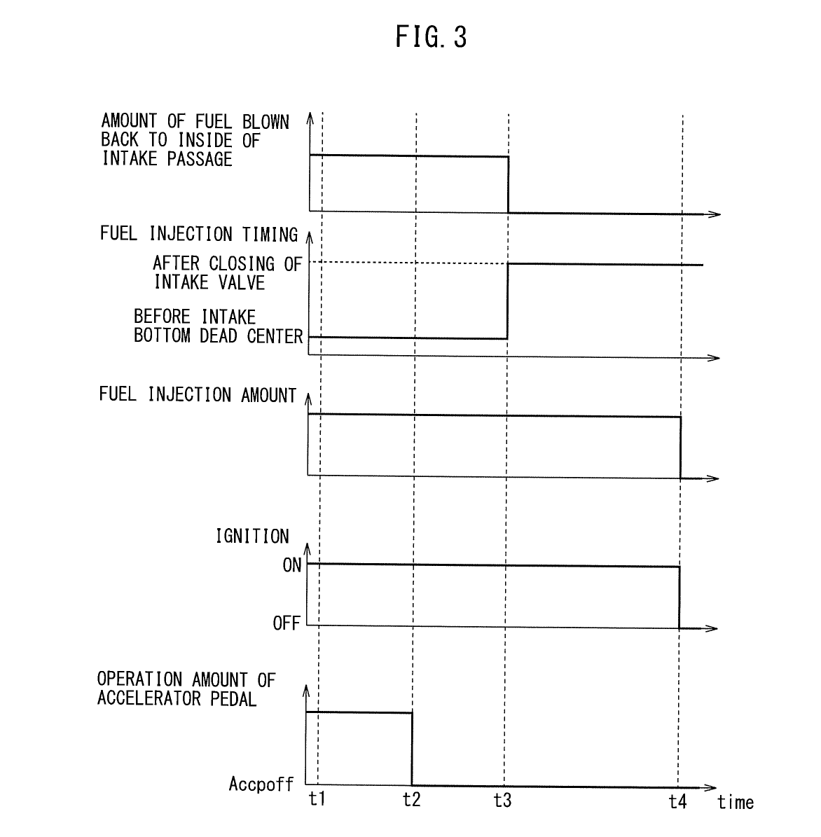

Next, the fuel cut control which is actually carried out by the electronic control unit 70 of the present control system will be explained with reference to the timing chart in FIG. 3. Note that, the timing chart shown in FIG. 3 shows the case where the valve characteristic of the intake valve 32 is the first valve characteristic. FIG. 3 shows a change according to time of the amount of the fuel which is blown back to the inside of the intake passage and a change of the closing timing of the intake valve 32 according to the unit crank angle. Further, FIG. 3 shows a change according to time of the fuel injection amount from the cylinder injector 39, a change according to time of the fuel injection timing from the cylinder injector 39, and a change according to time of the accelerator opening Accp of the accelerator pedal 81.

In the period from the time t1 to the time t2, the accelerator opening Accp of the accelerator pedal 81 becomes larger than Accpoff at which the accelerator opening becomes zero, therefore the execution condition is not satisfied. At the crank angle θ2, the accelerator opening Accp of the accelerator pedal 81 becomes Accpoff at which the acceleration becomes OFF, so it is judged that the execution condition is satisfied. After that, at the time t3, the fuel injection timing from the cylinder injector 39 is switched from a time before intake bottom dead center to a time after closing of the intake valve 32, and the ignition from the spark plug 39 is continued. Further, along with the change of the fuel injection timing of the cylinder injector 39, the amount of the fuel which is blown back to the inside of the intake passage decreases. After that, due to fuel cut control at the time t4, the fuel injection amount from the cylinder injector 39 becomes zero. Further, the ignition of the spark plug 39 is set OFF at the time t4, so the ignition by the spark plug 39 is no longer carried out.

[Actual Operation]

Next, actual operation of the present control system will be explained.

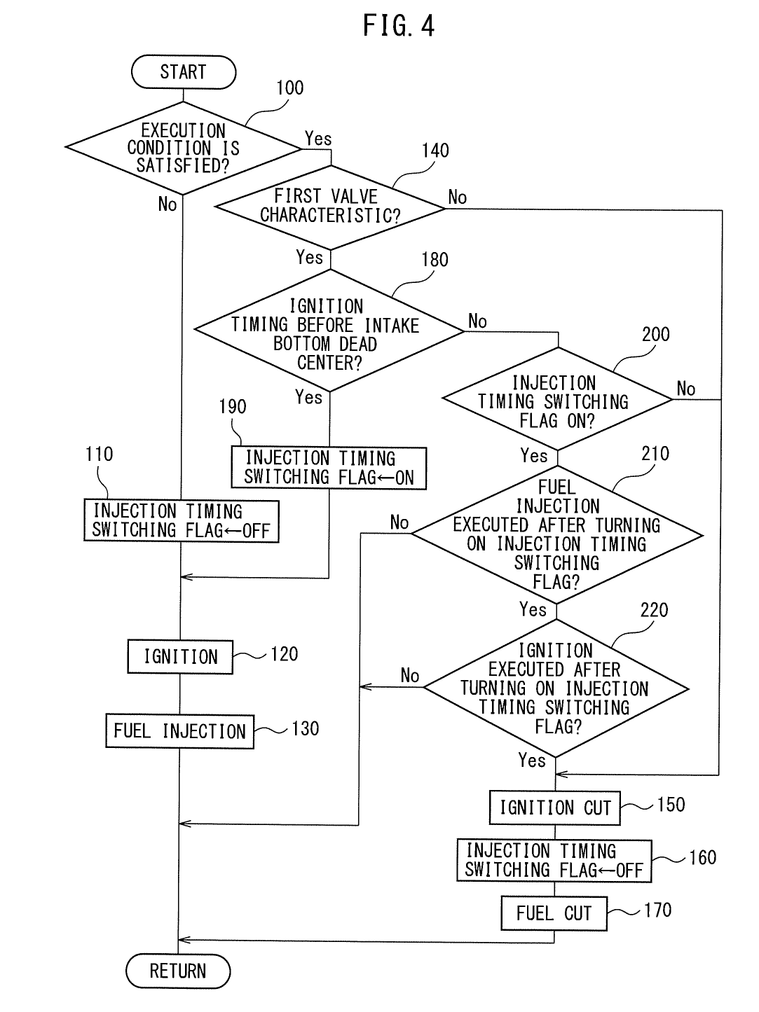

The CPU 71 of the present control system (below, referred to as the “CPU”) is configured to execute the fuel cut control routine shown in the flow chart in FIG. 4 at each predetermined timing after the start of the engine. Accordingly, the CPU starts the processing of step 100 at a suitable timing and judges whether the execution condition is satisfied. Here, a case where the execution condition is not satisfied will be explained first.

When the execution condition is not satisfied, at step 100, the CPU judges “No”, proceeds to step 110, and sets the “injection timing switching flag” showing the switching of the fuel injection timing from the cylinder injector 39 from a time before intake bottom dead center to a time after closing of the intake valve 32 to OFF.

After the processing of step 110, the CPU proceeds to step 120 where it sets the system to perform ignition from the spark plug 37.

After the processing of step 120, the CPU proceeds to step 130 where it sets the system so as to inject the fuel from the cylinder injector 39 then ends the present routine.

Next, a case where the execution condition is satisfied and the valve characteristic of the intake valve 32 is the second valve characteristic will be explained. Since the execution condition is satisfied at step 100, the CPU judges “Yes” and executes the processing of step 140. By executing the processing of step 140, the CPU judges whether the valve characteristic of the intake valve 32 is the first valve characteristic.

Since the valve characteristic of the intake valve 32 is the second valve characteristic, the CPU judges “No” at step 140, proceeds to step 150 where it sets the system so as to suspend ignition from the spark plug 37.

The CPU proceeds to step 160 after execution of the processing of step 150. If the injection timing switching flag is ON, the CPU sets this to OFF.

After execution of the processing of step 160, the CPU proceeds to step 170 where it sets the system so as to suspend the injection of the fuel from the cylinder injector 39 and thereby execute fuel cut control, then ends the present routine.

Next, a case where the execution condition is satisfied, the valve characteristic of the intake valve 32 is the first valve characteristic, and the fuel injection timing of the cylinder injector 39 is before intake bottom dead center will be explained. The CPU executes the processing of steps 100 and 140 in order. Since the valve characteristic of the intake valve 32 is the first valve characteristic, the CPU judges the processing of step 140 as “Yes”, then proceeds to step 180.

The CPU judges at step 180 whether the fuel injection timing of the cylinder injector 39 is before intake bottom dead center. Since the fuel injection timing of the cylinder injector 39 is before intake bottom dead center, the CPU judges the processing of step 180 as “Yes”, then proceeds to step 190.

At step 190, the CPU changes the fuel injection timing from the cylinder injector 39 from the time before intake bottom dead center to the time after closing of the intake valve 32 and sets the injection timing switching flag to ON.

After execution of the processing of step 190, the CPU executes the processing of step 120 and step 130 explained above in order, then ends the present routine.

Next, a case where the execution condition is satisfied, the valve characteristic of the intake valve 32 is the first valve characteristic, and the fuel injection timing of the cylinder injector 39 is not before intake bottom dead center will be explained. The CPU executes the processing of step 100, step 140, step 180, and step 200 in order. The CPU judges at step 200 whether the injection timing switching flag is ON. When the injection timing switching flag is OFF, the CPU judges the processing of step 200 as “No”, executes the processing of step 150, step 160, and step 170 explained above in order, then ends the present routine.

At step 200, the CPU judges step 200 as “Yes” when the injection timing switching flag is ON, then proceeds to step 210. At step 210, the CPU judges whether the injection of the fuel from the cylinder injector 39 is executed after turning ON the injection timing switching flag. In other words, at step 210, the CPU judges whether the fuel injection is executed since the injection timing of fuel of the cylinder injector 39 is switched from a time before intake bottom dead center to a time after closing of the intake valve 32. When the injection of the fuel from the cylinder injector 39 is not executed after turning ON the injection timing switching flag, the CPU judges the processing of step 210 as “No”, then ends the present routine.

When the injection of the fuel from the cylinder injector 39 is executed after turning ON the injection timing switching flag, the CPU judges the processing of step 210 as “Yes”, then proceeds to step 220. At step 220, the CPU judges whether ignition is carried out from the spark plug 37 after turning ON the injection timing switching flag. When the ignition is not executed from the spark plug 37 after turning ON the injection timing switching flag, the CPU judges the processing of step 220 as “No”, then ends the present routine.

When ignition has been carried out from the spark plug 37 after turning ON the injection timing switching flag, the CPU judges the processing of step 220 as “Yes”, then proceeds to step 150. At step 150, the CPU sets the system so as to suspend the ignition from the spark plug 37.

After execution of the processing of step 150, the CPU sets the injection timing switching flag to OFF at step 160.

After execution of the processing of step 160, the CPU sets the system at step 170 so as to suspend the injection of the fuel from the cylinder injector 39, executes the fuel cut control, then ends the present routine.

As explained above, according to this present control system, the fuel injection timing of the cylinder injector 39 is delayed to the time after closing of the intake valve 32, therefore the amount of the fuel which is blown back to the inside of the intake passage in the period when the intake valve is open after intake bottom dead center becomes zero. As a result, the amount of the fuel which flows into the exhaust passage as unburned gas when the fuel cut control is carried out can be reduced. In addition, the present control system is configured to suspend the ignition from the spark plug 37 during execution of the fuel cut control, therefore combustion inside a cylinder of the air-fuel mixture which contains the fuel again flowing into the cylinder after being blown back to the inside of the intake passage in a part of the cylinders is suppressed. Therefore, occurrence of “after fire” by the air-fuel mixture which was not completely burned, but flowed in the exhaust passage can be suppressed.

[Modification of Present Control System]

The CPU of the modification is different only in the point that, at step 190 of the “fuel cut control” routine shown in FIG. 4 in the present control system, the fuel injection timing from the cylinder injector 39 is changed from a timing before intake bottom dead center to a timing which is before closing of the intake valve 32 and at which the pressure inside the cylinder rises per unit crank angle.

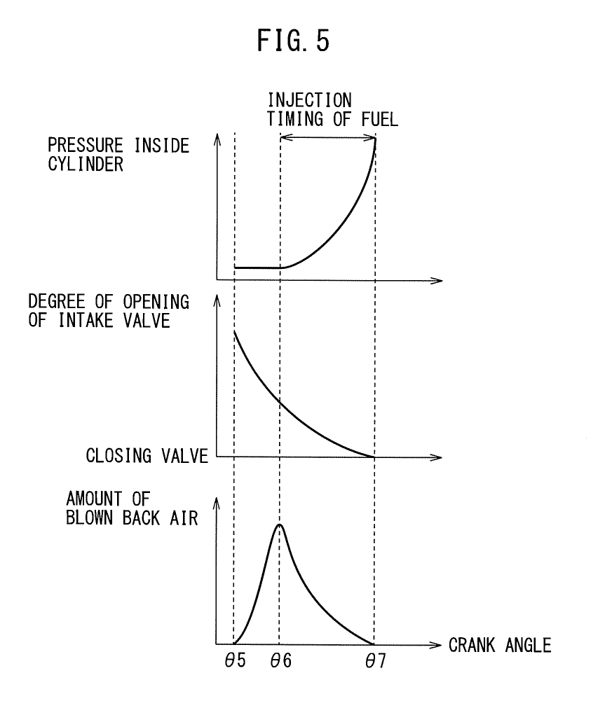

Specifically, the fuel injection timing from the cylinder injector 39 will be explained with reference to FIG. 5. FIG. 5 shows a change of the pressure inside the cylinder at a unit crank angle, a change of the valve opening of the intake valve 32 at a unit crank angle, and a change of the amount of air which is blown back to the inside of the intake passage at a unit crank angle. In the period from the crank angle θ5 at which intake bottom dead center BDC is obtained to θ6 after intake bottom dead center BDC, the speed of the piston 22 is fast and the degree of opening of the intake valve 32 is large, therefore the amount of air which is blown back to the inside of the intake passage increases. For this reason, in the period from the crank angle θ5 to θ6, the amount of the fuel which is blown back to the inside of the intake passage increases along with the increase of the amount of air which is blown back to the inside of the intake passage. For the period from the crank angle θ6 to θ7, the amount of the air which is blown back to the inside of the intake passage decreases along with the reduction of the degree of opening of the intake valve 32, therefore the pressure inside the cylinder rises. Further, in the period from the crank angle θ6 to θ7, the amount of the fuel which is blown back to the inside of the intake passage decreases along with the reduction of the amount of the blown back air. For this reason, at step 190, the CPU sets the injection timing of the fuel of the cylinder injector 39 to a timing which is between the crank angles θ6 and θ7 of the period where the pressure inside the cylinder detected by the cylinder inner pressure sensor 65 rises per unit crank angle as shown in the timing chart in FIG. 5 and becomes the period in which the degree of opening of the intake valve 32 becomes small.

According to this, the amount of the fuel which is blown back to the inside of the intake passage can be reduced. In addition, compared with the case where the fuel injection timing from the cylinder injector 39 is set to a time after closing of the intake valve 32, the time of atomizing the fuel can be made longer, therefore deterioration of combustion can be suppressed.

Note that, the CPU in this modification may be configured so that rather than using the pressure inside the cylinder detected by the cylinder inner pressure sensor 65, a map showing the relationship between the degree of opening of the intake valve 32 and the pressure inside the cylinder is set in advance and this map is used as the basis to set the fuel injection timing from the cylinder injector 39.

As explained above, by the control system according to the embodiment and modification of the present invention, the fuel injection timing of the cylinder injector 39 is delayed to a time after intake bottom dead center, therefore the amount of the fuel which is blown back to the inside of the intake passage in the period when the intake valve is open after intake bottom dead center can be reduced. As a result, the amount of the fuel which flows into the exhaust passage as unburned gas when fuel cut control is carried out can be reduced.

Note that, the present invention is not limited to the embodiment and modification described above. Various modifications can be made within the scope of the present invention. For example, the internal combustion engine may be a variable compression ratio internal combustion engine capable of changing the mechanical compression ratio. In a variable compression ratio internal combustion engine, the mechanical compression ratio can be changed to make the amount of delay of the closing timing of the intake valve larger, therefore the amount of the fuel which is blown back to the inside of the intake passage becomes larger. Accordingly, by applying the present invention to a variable compression ratio internal combustion engine, the amount of the fuel which is blown back to the inside of the intake passage can be further reduced.

Further, the present embodiment and modification do not have to employ a configuration capable of changing the closing timing of the intake valve 32 and may employ for example a configuration in which the characteristic of the intake valve is only the first valve characteristic. Further, when a configuration capable of changing the closing timing of the intake valve 32, it may be a configuration such as a VVT in which the phase of the cam is changed.

Further, in the present embodiment and modification, the injection timing of the fuel from the cylinder injector 39 at the second injection timing may be a time after intake bottom dead center.

### REFERENCE SIGNS LIST

10 . . . internal combustion engine, 32 . . . intake valve, 33 . . . intake valve driving device, 37 . . . spark plug, 39 . . . cylinder injector, 70 . . . electronic control unit, and 71 . . . CPU.

1. A control system of an internal combustion engine comprising
a spark plug,
an intake valve,
a cylinder injector injecting fuel into a cylinder, and
an intake valve driving device driving the intake valve so as to close after intake bottom dead center, wherein
the control system comprises
an ignition controlling means for controlling ignition of the spark plug,
an injection controlling means capable of switching an injection timing of a fuel of the cylinder injector to a first injection timing which is before intake bottom dead center and to a second injection timing which is after intake bottom dead center, and
a fuel cut controlling means for executing a fuel cut control suspending the injection of the fuel from the cylinder injector when a predetermined execution condition is satisfied and
the control system is configured to execute the fuel cut control after a cycle of injecting the fuel at the second injection timing and executing ignition if the execution condition is satisfied in a cycle where the injection timing of the fuel of the cylinder injector is the first injection timing.

2. The control system of an internal combustion engine according to claim 1, wherein the second injection timing is after closing of the intake valve.

3. The control system of an internal combustion engine according to claim 1, wherein the second injection timing is before closing of the intake valve and is within a time period wherein a pressure inside the cylinder rises per unit crank angle.

4. The control system of an internal combustion engine according to claim 1, wherein:
the internal combustion engine has plurality of the cylinders, and
the spark plug controlling means is configured to control the spark plug so as not to execute the ignition during the fuel cut control.

5. The control system of an internal combustion engine according to claim 2, wherein:
the internal combustion engine has plurality of the cylinders, and
the spark plug controlling means is configured to control the spark plug so as not to execute the ignition during the fuel cut control.

6. The control system of an internal combustion engine according to claim 3, wherein:
the internal combustion engine has plurality of the cylinders, and
the spark plug controlling means is configured to control the spark plug so as not to execute the ignition during the fuel cut control.

7. A control system of an internal combustion engine comprising
a spark plug,
an intake valve,
a cylinder injector injecting fuel into a cylinder,
an intake valve driving device driving the intake valve so as to close after intake bottom dead center, and
an electronic control unit, wherein
the electronic control unit is configured to control ignition of the spark plug,
switch an injection timing of a fuel of the cylinder injector to a first injection timing which is before intake bottom dead center and to a second injection timing which is after intake bottom dead center,
execute a fuel cut control suspending the injection of the fuel from the cylinder injector when a predetermined execution condition is satisfied, and
execute the fuel cut control after a cycle of injecting the fuel at the second injection timing and executing ignition if the execution condition is satisfied in a cycle where the injection timing of the fuel of the cylinder injector is the first injection timing.

8. The control system of an internal combustion engine according to claim 7, wherein the second injection timing is after closing of the intake valve.

9. The control system of an internal combustion engine according to claim 7, wherein the second injection timing is before closing of the intake valve and is within a time period wherein a pressure inside the cylinder rises per unit crank angle.

10. The control system of an internal combustion engine according to claim 7, wherein:
the internal combustion engine has plurality of the cylinders, and
the electronic control unit is configured to control the spark plug so as not to execute the ignition during the fuel cut control.

11. The control system of an internal combustion engine according to claim 8, wherein:
the internal combustion engine has plurality of the cylinders, and
the electronic control unit is configured to control the spark plug so as not to execute the ignition during the fuel cut control.

12. The control system of an internal combustion engine according to claim 9, wherein:
the internal combustion engine has plurality of the cylinders, and
the electronic control unit is configured to control the spark plug so as not to execute the ignition during the fuel cut control.
